(19) United States
(12) Patent Application Publication
(10) Pub. No.: US 2023/0015998 A1
(43) Pub. Date: Jan. 19, 2023

(54) METHOD, DEVICE AND COMPUTER STORAGE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/783,697

(22) PCT Filed: Dec. 9, 2019
(86) PCT No.: PCT/CN2019/124104

§ 371 Date: Jun. 9, 2022

(51) Int. Cl. H04W 72/04; H04L 5/00

(52) U.S. Cl. CPC H04W 72/0453; H04L 5/0005

(57) ABSTRACT

Embodiments of the present disclosure relate to methods, devices and computer storage media for communication. A method comprises determining, at a network device, a variable for transform pre-coding to be performed by the network device or a terminal device served by the network device; and transmitting, to the terminal device, information about the variable for the transform pre-coding. Embodiments of the present disclosure can achieve high resource efficiency and low PAPR at the same time in downlink transmissions.

### TECHNICAL FIELD

Embodiments of the present disclosure generally relate to the field of telecommunication, and in particular, to methods, devices and computer storage media for communication.

### BACKGROUND

In Long Term Evolution (LTE) uplink transmissions, a terminal device (such as, UE) may perform transform pre-coding (such as, Discrete Fourier Transform, DFT) on data to be transmitted, generate Single Carrier-Frequency Division Multiple Access (SC-FDMA) signals based on the pre-coded data and transmit the SC-FDMA signals to a network device (such as, a base station). The SC-FDMA signals can be generated in time or frequency domain. In LTE uplink transmissions, the SC-FDMA signals are generated in the frequency domain, namely Discrete Fourier Transform-spread-Orthogonal Frequency Division Multiplexing (DFT-s-OFDM) technology.

In new radio access (NR), transform pre-coding (DFT) may be performed for uplink transmissions, and Orthogonal Frequency Division Multiplexing (OFDM) signals are generated for all channels except Physical Random Access Channel (PRACH). Moreover, study on NR beyond 52.6 GHz has been discussed. Compared with the OFDM technology, the SC-FDMA/DFT-S-OFDM technology can achieve much lower Peak-to-Average Power Ratio (PAPR). Therefore, it would be desirable to keep low PAPR on a high frequency band (such as, beyond 52.6 Ghz). It would also be desirable to reuse the current SC-FDMA/DFT-s-OFDM technology as much as possible and achieve high resource efficiency and low PAPR at the same time.

### SUMMARY

In general, example embodiments of the present disclosure provide methods, devices and computer storage media for communication.

In a first aspect, there is provided a method of communication. The method comprises: determining, at a network device, a variable for transform pre-coding to be performed by the network device or a terminal device served by the network device; and transmitting, to the terminal device, information about the variable for the transform pre-coding.

In a second aspect, there is provided a method of communication. The method comprises: receiving, at a terminal device and from a network device serving the terminal device, information about a variable for transform pre-coding to be performed by the network device or the terminal device; and determining, based on the information, the variable for the transform pre-coding.

In a third aspect, there is provided a network device. The network device comprises a processor and a memory coupled to the processor. The memory stores instructions that when executed by the processor, cause the network device to perform actions. The actions comprises: determining a variable for transform pre-coding to be performed by the network device or a terminal device served by the network device; and transmitting, to the terminal device, information about the variable for the transform pre-coding.

In a fourth aspect, there is provided a terminal device. The terminal device comprises a processor and a memory coupled to the processor. The memory stores instructions that when executed by the processor, cause the terminal device to perform actions. The actions comprises: receiving, from a network device serving the terminal device, information about a variable for transform pre-coding to be performed by the network device or the terminal device; and determining, based on the information, the variable for the transform pre-coding.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2A illustrates an example signaling chart showing an example process for downlink transmissions in accordance with some embodiments of the present disclosure;

FIG. 2B illustrates an example signaling chart showing an example process for downlink transmissions in accordance with some embodiments of the present disclosure;

FIG. 3A illustrates an example schematic diagram of resource allocation in accordance with some embodiments of the present disclosure;

FIG. 3B illustrates an example schematic diagram of resource allocation in accordance with some embodiments of the present disclosure;

FIG. 4 illustrates a flowchart of an example method in accordance with some embodiments of the present disclosure;

FIG. 5 illustrates a flowchart of an example method in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As described above, in LTE uplink transmissions, a terminal device may perform transform pre-coding (DFT) on data to be transmitted, generate SC-FDMA signals based on the pre-coded data and transmit the SC-FDMA signals to a network device. The SC-FDMA signals can be generated in time or frequency domain. In LTE uplink transmissions, the SC-FDMA signals are generated in the frequency domain, namely DFT-s-OFDM technology.

In NR, transform pre-coding (DFT) may be performed for uplink transmissions, and OFDM/SC-FDMA/DFT-s-OFDM signals are generated for all channels except PRACH. Moreover, study on NR beyond 52.6 GHz has been discussed. Compared with the OFDM technology, the SC-FDMA/DFT-S-OFDM technology can achieve much lower PAPR. Therefore, it would be desirable to keep low PAPR on a high frequency band (such as, beyond 52.6 Ghz). It would also be desirable to reuse the current SC-FDMA/DFT-s-OFDM technology as much as possible and achieve high resource efficiency and low PAPR at the same time.

In current 3GPP specifications for NR, transform pre-coding can be enabled for Physical Uplink Shared Channel (PUSCH), where the number of points for the transform pre-coding depends on the bandwidth of the PUSCH in terms of resource blocks. However, no discussion is available for downlink transmissions. In order to achieve high resource efficiency in downlink transmissions, Frequency Division Multiplexing (FDM) based resource allocation is preferred. However, FDM based resource allocation will cause high PAPR.

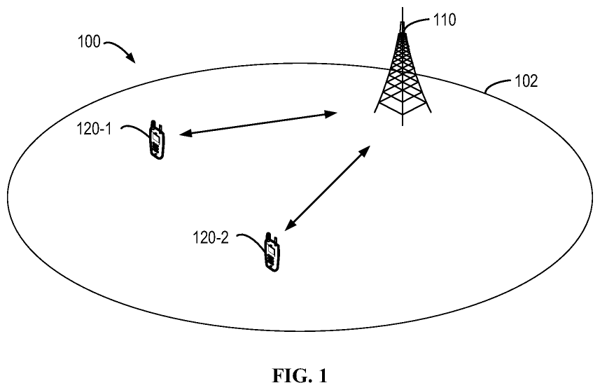

Embodiments of the present disclosure provide a solution to solve the problem above and one or more of other potential problems. This solution can reuse the current SC-FDMA/DFT-s-OFDM technology as much as possible and achieve high resource efficiency and low PAPR at the same time in downlink transmissions. Principle and implementations of the present disclosure will be described in detail below with reference to FIGS. 1-6.

FIG. 1 illustrates a schematic diagram of an example communication system 100 in which embodiments of the present disclosure can be implemented. As shown in FIG. 1, the communication system 100 may include a network device 110 and terminal devices 120-1 and 120-2 (collectively referred to as “terminal devices 120” or individually referred to as “terminal device 120”). The network 100 can provide one or more cells 102 to serve the terminal device 120. It is to be understood that the number of network devices, terminal devices and/or cells is given for the purpose of illustration without suggesting any limitations to the present disclosure. The communication network 100 may include any suitable number of network devices, terminal devices and/or cells adapted for implementing implementations of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 130.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via Radio Resource Control (RRC) signaling.

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit control information via Physical Downlink Control Channel (PDCCH) and/or transmit data via a Physical Downlink Shared Channel (PDSCH) to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit control information via Physical Uplink Control Channel (PUCCH) and/or transmit data via Physical Uplink Shared Channel (PUSCH) to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DMRS, CSI-RS, SRS, PTRS, fine time and frequency TRS and so on.

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

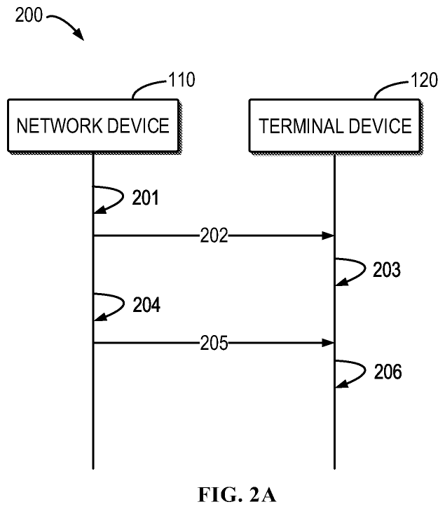

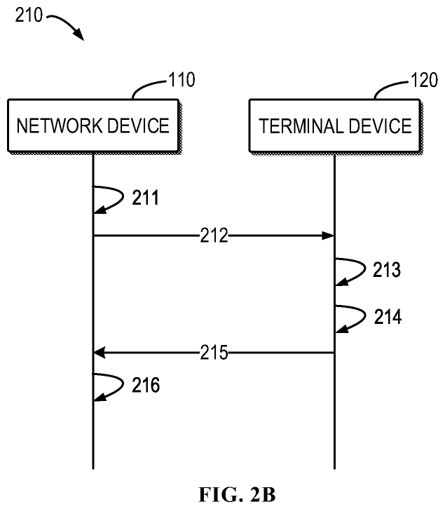

FIG. 2A illustrates an example signaling chart showing an example process 200 for downlink transmissions in accordance with some embodiments of the present disclosure. As shown in FIG. 2A, the process 200 may involve the network device 110 and the terminal device 120 as shown in FIG. 1. It is to be understood that the process 200 may include additional acts not shown and/or may omit some acts as shown, and the scope of the present disclosure is not limited in this regard.

As shown in FIG. 2A, the network device 110 determines 201 a variable for transform pre-coding (such as, DFT) to be performed by the network device 110. In some embodiments, for example, the variable may indicate a number of points for the transform pre-coding. Then, the network device 110 transmits 202, to the terminal device 120, information about the variable for the transform pre-coding. In response to receiving 202 the information about the variable from the network device 110, the terminal device 120 determines 203, based on the information, the variable for inverse transform pre-coding (such as, Inverse Discrete Fourier Transform, IDFT) to be performed by the terminal device 120.

As shown in FIG. 2A, for DL transmissions, the network device 110 performs 204, based on the determined variable (such as, the number of points), the transform pre-coding on a signal (for example, DL control information, data or a DL RS) to be transmitted to the terminal device 120 and transmit 205 the pre-coded signal to the terminal device 120. In response to receiving 205 from the network device 110 the signal on which the transform pre-coding is performed based on the variable, the terminal device 120 performs 206, based on the variable, the inverse transform pre-coding on the signal.

FIG. 2B illustrates an example signaling chart showing an example process 210 for uplink transmissions in accordance with some embodiments of the present disclosure. As shown in FIG. 2B, the process 210 may involve the network device 110 and the terminal device 120 as shown in FIG. 1. It is to be understood that the process 210 may include additional acts not shown and/or may omit some acts as shown, and the scope of the present disclosure is not limited in this regard.

As shown in FIG. 2B, the network device 110 determines 211 a variable for transform pre-coding (such as, DFT) to be performed by the terminal device 120. In some embodiments, for example, the variable may indicate a number of points for the transform pre-coding. Then, the network device 110 transmits 212, to the terminal device 120, information about the variable for the transform pre-coding. In response to receiving 212 the information about the variable from the network device 110, the terminal device 120 determines 213, based on the information, the variable for the transform pre-coding to be performed.

As shown in FIG. 2B, for UL transmissions, the terminal device 120 performs 214, based on the determined variable (such as, the number of points), the transform pre-coding on a signal (for example, UL control information, data or a UL RS) to be transmitted to the network device 110 and transmit 215 the pre-coded signal to the network device 110. In response to receiving 215 from the terminal device 120 the signal on which the transform pre-coding is performed based on the variable, the network device 110 performs 216, based on the variable, the inverse transform pre-coding (such as, IDFT) on the signal.

In some embodiment, for downlink transmissions, there may be a parameter to indicate whether the transform pre-coding is enabled or disabled. In some embodiments, there are various modulation techniques that can be supported, such as Binary Phase Shift Keying (BPSK), π/2-BPSK, Quadrature Phase Shift Keying (QPSK), 16 Quadrature Amplitude Modulation (16QAM), 64QAM, 256QAM and 1024QAM. For downlink transmissions, if the transform pre-coding is disabled, there may be only a part of modulation techniques that are applicable, for example, BPSK, π/2-BPSK and QPSK.

In some embodiment, for downlink transmissions, if the transform pre-coding is enabled, the network device 110 may determine the variable (such as, the number of points) for the transform pre-coding (such as, DFT) to be performed by the network device 110 and transmit the information about the variable to the terminal device 120. In some embodiment, for uplink transmissions, the network device 110 may determine the variable (such as, the number of points) for the transform pre-coding (such as, DFT) to be performed by the terminal device 120 and transmit the information about the variable to the terminal device 120.

In some embodiments, for downlink or uplink transmissions, in order to determine the variable for the transform pre-coding, the network device 110 may determine a number of frequency resources allocated to the terminal device 120 and determine the variable (such as, the number of points) for the transform pre-coding based on the number of frequency resources.

In some embodiments, a number of resource blocks (RBs) may be allocated to the terminal device 120 (such as, the terminal device 120-1 or 120-2). For example, the number of RBs allocated to the terminal device 120 may be represented as R, where R>0 and R is an integer. For example, 1≤R≤476. For example, the R RBs may be allocated for PDSCH/PDCCH/PUSCH/PUCCH. The network device 110 may determine the variable (such as, the number of points) for the transform pre-coding (such as, DFT) as X, where X>0 and X is an integer. For example, 1≤X≤476. In some embodiments, X≥R·N, where N represents the number of subcarriers included in one resource block. For example, if N=12, then X≥12·R. For another example, N can be any one of {1, 2, 3, 4, 5, 6, 7, 8, 9, 10, 11, 12}.

In some embodiments, for downlink or uplink transmissions, in order to determine the variable for the transform pre-coding, the network device 110 may determine a number of frequency resources allocated to a plurality of terminal devices comprising the terminal device 120, where the plurality of terminal devices are scheduled based on FDM in a same symbol. The network device 110 may determine the variable (such as, the number of points) for the transform pre-coding based on the number of frequency resources.

In some embodiments, a number of resource blocks (RBs) may be allocated to a plurality of terminal devices (such as, the terminal devices 120-1 and 120-2) which are scheduled based on FDM in a same symbol. For example, the total number of RBs allocated to the terminal devices may be represented as R, where R>0 and R is an integer. For example, 1≤R≤476. The network device 110 may determine the variable (such as, the number of points) for the transform pre-coding (such as, DFT) as X, where R>0 and X is an integer. For example, 1≤X≤476. In some embodiments, X≥R·N, where N represents the number of subcarriers included in one resource block. For example, if N=12, then X≥12·R. For another example, N is an integer, and N can be any one of {1, 2, 3, 4, 5, 6, 7, 8, 9, 10, 11, 12}.

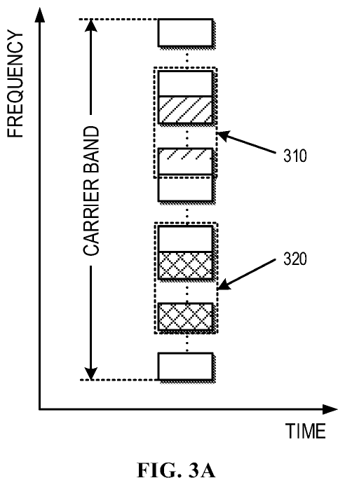

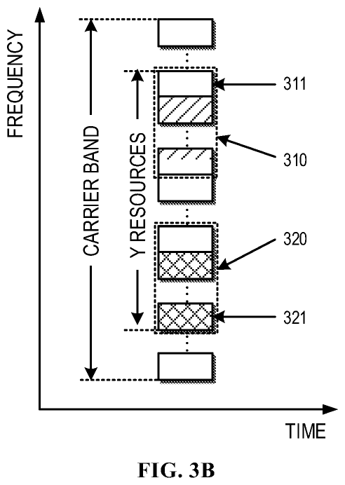

FIG. 3A illustrates an example schematic diagram of such embodiments. In FIG. 3A, each block may represent a RB. As shown in FIG. 3A, for example, the network device 110 may allocate RBs 310 to the terminal device 120-1 and may allocate RBs 320 the terminal device 120-2. It is assumed that the network device 110 only serve the two terminal devices 120-1 and 120-2. In some embodiments, the network device 110 may determine the variable (such as, the number of points) for the transform pre-coding based on the total number of RBs 310 and 320. For example, the variable (such as, the number of points) for the transform pre-coding may be equal to or greater than the total number of subcarriers in the RBs 310 and 320.

In some embodiments, in order to indicate the variable for the transform pre-coding to the terminal device 120, the network device 110 may transmit a message indicating the number of frequency resources (such as, R) or the number of points (such as, X) to the terminal device 120. In some embodiments, the network device 110 may transmit the message to the terminal device 120 via any of the following: Radio Resource Control (RRC) signaling, Medium Access Control (MAC) control element (CE) or Downlink Control Information (DCI).

In some embodiments, in response to receiving the message from the network device 110, the terminal device 120 may determine the variable (such as, the number of points) X for the transform pre-coding or inverse transform pre-coding based on the message. For example, the terminal device 120 can determine the variable for the transform pre-coding or inverse transform pre-coding based on a same rule as the network device 110, as described above.

Alternatively, in some embodiments, for downlink or uplink transmissions, in order to determine the variable for the transform pre-coding, the network device 110 may determine a plurality of frequency resources allocated to a plurality of terminal devices comprising the terminal device 120, where the plurality of terminal devices are scheduled based on FDM in a same symbol. In some embodiments, the plurality of frequency resources may be discontinuous in the frequency domain. In some embodiments, the network device 110 may determine a starting frequency resource and an ending frequency resource of the plurality of frequency resources. The network device 110 may determine a number of frequency resources between the starting frequency resource and the ending frequency resource, and then determine the variable (such as, the number of points) for the transform pre-coding based on the number of frequency resources.

In some embodiments, a plurality of RBs may be allocated to a plurality of terminal devices (such as, the terminal devices 120-1 and 120-2) which are scheduled based on FDM in a same symbol. In some embodiments, the plurality of RBs may be discontinuous in the frequency domain. For example, a starting RB of the plurality of RBs may be indexed with S and an ending RB of the plurality of RBs may be indexed with E, where S and E are both non-negative integers and E>S. For example, 0≤E≤476. For example, 0≤S≤476. The network device 110 may determine the number of RBs between the starting RB and the ending RB as Y, where Y=E−S+1. Then, the network device 110 may determine the variable (such as, the number of points) for the transform pre-coding (such as, DFT) as X, where X>0 and X is an integer. In some embodiments, X≥Y·N, where N represents the number of subcarriers included in one resource block. For example, if N=12, then X≥12·Y.

FIG. 3B illustrates an example schematic diagram of such embodiments. In FIG. 3B, each block may represent a RB. As shown in FIG. 3B, for example, the network device 110 may allocate RBs 310 to the terminal device 120-1 and may allocate RBs 320 the terminal device 120-2. It is assumed that the network device 110 only serve the two terminal devices 120-1 and 120-2. For example, the staring RB of the RBs 310 and 320 is shown as RB 321 in FIG. 3B, and the ending RB of the RBs 310 and 320 is shown as RB 311 in FIG. 3B. There may be Y RBs between the RB 321 and the RB 311. In some embodiments, the network device 110 may determine the variable (such as, the number of points) for the transform pre-coding based on the number of RBs between the RB 321 and the RB 311, that is, Y. For example, the variable (such as, the number of points) for the transform pre-coding may be equal to or greater than the total number of subcarriers in the Y RBs.

In some embodiments, in order to indicate the variable to the terminal device 120, the network device 110 may transmit at least one message indicating a first index of the starting frequency resource (such as, S) and a second index of the ending frequency resource (such as, E) to the terminal device 120. In some embodiments, the network device 110 may transmit the at least one message to the terminal device 120 via at least one of the following: RRC signaling, MAC CE and DCI.

In some embodiments, in response to receiving the at least one message from the network device 110, the terminal device 120 may determine the variable (such as, the number of points) for the transform pre-coding or inverse transform pre-coding based on the at least one message. For example, the terminal device 120 may determine a number of frequency resources between the starting frequency resource and the ending frequency resource, and then determine the variable for the transform pre-coding or inverse transform pre-coding based on the number of frequency resources. It is to be understood that the terminal device 120 can determine the variable for the transform pre-coding or inverse transform pre-coding based on a same rule as the network device 110, as described above.

In some embodiments, a plurality of RBs may be allocated to the terminal device 120 (such as, the terminal device 120-1 or 120-2). For example, the total number of RBs allocated to the terminal device 120 may be represented as R, where R>0 and R is an integer. For example, 1≤R≤476. For example, the R RBs may be allocated for PDSCH/PDCCH/PUSCH/PUCCH. In some embodiments, the R RBs may be contiguous in frequency domain. In other embodiments, the R RBs may be discontinuous in frequency domain. For example, the starting RB within the R RBs allocated to the terminal device 120 may be indexed with L, where L≥0 and L is an integer. For example, 0≤L≤476. For another example, the ending RB within the R RBs allocated to the terminal device 120 may be indexed with H, where H≥0 and H is an integer. For example, 0≤H≤476.

In some embodiments, there may be Y RBs in the frequency domain, where Y>0 and Y is an integer, and Y≤R. For example, 1≤Y≤476. In some embodiments, the network device 110 (and/or the terminal device 120) may determine the variable (such as, the number of points) for the transform pre-coding (such as, DFT) as X, where X>0 and X is an integer. In some embodiments, X≥Y·N, where N represents the number of subcarriers included in one resource block. For example, if N=12, then X≥12·Y. For another example, N can be any one of {1, 2, 3, 4, 5, 6, 7, 8, 9, 10, 11, 12}.

In some embodiments, a starting RB of the Y RBs may be indexed with S, an ending RB of the Y RBs may be indexed with E and the number of indices of the Y RBs may be represented as M, where S and E are both non-negative integers, and M is a positive integer. For example, 0≤S≤476, 0≤E≤476 and E>S. For example, 1≤M≤476. For example, M=Y.

In some embodiments, the Y RBs may be same as a bandwidth part, which is a subset of contiguous resource blocks defined in 3GPP technical specification 38.211. For example, Y=N_{BWP,i}^{size,μ}, where N_{BWP,i}^{size,μ} is the number of RBs in a bandwidth part. For another example, S=N_{BWP,i}^{start,μ}, where N_{BWP,i}^{start,μ} is the starting position of a bandwidth part. For another example, E=N_{BWP,i}^{start,μ}+N_{BWP,i}^{size,μ}.

In some embodiments, the Y RBs may be same as the carrier bandwidth, which is a number of contiguous resource blocks. For example, Y=N_{grid}^{size,μ}, where N_{grid}^{size,μ} is the number of RBs of a carrier bandwidth. For another example, S=N_{grid}^{start,μ}, where N_{grid}^{start,μ} is the starting common resource block of the carrier bandwidth. For another example, E=N_{grid}^{start,μ}+N_{grid}^{size,μ}.

In some embodiments, a plurality of RBs may be allocated to the terminal device 120 (such as, the terminal device 120-1 or 120-2). For example, the total number of RBs allocated to the terminal device 120 may be represented as R, where R>0 and R is an integer. For example, 1≤R≤476. For example, the R RBs may be allocated for PDSCH/PDCCH/PUSCH/PUCCH. In some embodiments, the R RBs may be discontinuous in frequency domain. For example, the starting RB of the R RBs allocated to the terminal device 120 may be indexed with L, where L≥0 and L is an integer. For example, 0≤L≤476. For another example, the ending RB of the R RBs allocated to the terminal device 120 may be indexed with H, where H≥0 and H is an integer. For example, 0≤H≤476. In some embodiments, the value of Y may be determined as: Y=H−L+1.

In some embodiments, an index offset between the starting RB of the Y RBs and the starting RB of the R RBs allocated to the terminal device 120 may be represented as O1, where O1 is a non-negative integer. For example, 0≤O1≤476. In some embodiments, S=L−O1. Alternatively, in some embodiments, S=L−O1−1. Alternatively, in some embodiments, S=L−O1+1.

In some embodiments, an index offset between the ending RB of the Y RBs and the ending RB of the R RBs allocated to the terminal device 120 may be represented as O2, where O2 is a non-negative integer. For example, 0≤O2≤476. In some embodiments, E=H+O2. Alternatively, in some embodiments, E=H+O2+1. Alternatively, in some embodiments, E=H+O2−1.

In some embodiments, a difference between the number of RBs allocated to the plurality of terminal devices and the number of RBs allocated to the terminal device 120 may be represented as O3, where O3 is a non-negative integer. For example, 0≤O3≤476. In some embodiments, M=R+O3. Alternatively, in some embodiments, M=R+O3+1. Alternatively, in some embodiments, M=R+O3−1.

In some embodiments, the network device 110 (and/or the terminal device 120) may determine the variable (such as, the number of points) for the transform pre-coding (such as, DFT) as X, where X>0 and X is an integer. In some embodiments, X=M·N. For example, N represents the number of subcarriers included in one resource block. For another example, N represents the number of subcarriers allocated to the terminal device 120 for PDCCH/PDSCH/PUSCH/PUCCH within one RB. For example, if N=12, then X=12·M. For another example, N can be any one of {1, 2, 3, 4, 5, 6, 7, 8, 9, 10, 11, 12}.

In some embodiments, a starting RB of the Y RBs may be indexed with S, and an ending RB of the Y RBs may be indexed with E, where S and E are both integers and E>S. For example, 0≤E≤476. For example, 0≤S≤476. For example, the network device 110 (and/or the terminal device 120) may determine the number of RBs between the starting RB and the ending RB as Y, where Y=E−S+1. Then, the network device 110 (and/or the terminal device 120) may determine the variable (such as, the number of points) for the transform pre-coding (such as, DFT) as X, where X>0 and X is an integer. In some embodiments, X=Y·N. For example, N represents the number of subcarriers included in one RB. For another example, N represents the number of subcarriers allocated to the terminal device 120 for PDCCH/PDSCH/PUSCH/PUCCH within one RB. For example, if N=12, then X=12·Y. For another example, N can be any one of {1, 2, 3, 4, 5, 6, 7, 8, 9, 10, 11, 12}.

In some embodiments, in order to indicate the variable for the transform pre-coding to the terminal device 120, the network device 110 may transmit one or more messages indicating values of at least one of parameters S, E, M, N, L, H, O1, O2, O3, R and Y to the terminal device 120. In some embodiments, the network device 110 may transmit the one or more messages to the terminal device 120 via at least one of the following: RRC signaling, MAC CE and DCI.

In some embodiments, in response to receiving the one or more messages from the network device 110, the terminal device 120 may determine the variable (such as, the number of points) for the transform pre-coding or inverse transform pre-coding based on the values of at least one of parameters S, E, M, N, L, H, O1, O2, O3, R and Y. For example, the terminal device 120 can determine the variable for the transform pre-coding or inverse transform pre-coding based on a same rule as the network device 110, as described above.

In some embodiments, there may be a set of candidate values for one of the parameters S, E, M, N, L, H, O1, O2, O3, R and Y, which are predefined via the RRC signaling and/or MAC CE. For example, the set of candidate values may be represented as {A1, A2, . . . Ak}, where Ai (1≤i≤k) follows the range of possible values of the corresponding parameter, k is a positive integer, and 1≤k≤64. In some embodiments, the network device 110 may indicate one value from the set of candidate values for the corresponding parameter to the terminal device 120 via any at least one of the following: RRC signaling, MAC CE and DCI. In some embodiments, for example, if the R RBs are allocated to the terminal device 120, the terminal device 120 may assume that the value of Y is the smallest candidate value which satisfies Ai≥R within the set of candidate values for the parameter Y.

In some embodiments, the network device 110 may not transmit the one or more messages indicating the values of S, E, M, N, L, H, O1, O2, O3, R and/or Y to the terminal device 120. In this event, for example, the network device 110 and/or the terminal device 120 may assume the value of the parameter S, E, M, N, L, H, O1, O2, O3, R or Y to be a fixed/predefined value.

In some embodiments, for any of PDCCH, PDSCH, PUSCH and PUCCH associated with the terminal device 120, there may be an associated RS, for example, DMRS. For example, the starting/lowest/smallest RB index for the associated RS may be S. The number of RBs allocated for the associated RS may be Y. The ending/highest/largest RB index for the associated RS may be E. For another example, the starting/lowest/smallest RB index for the associated RS may be L. The number of RBs allocated for the associated RS may be R. The ending/highest/largest RB index for the associated RS may be H. In some embodiments, the variable (such as, the number of points) for the transform pre-coding (DFT) for a channel (such as, PDCCH, PDSCH, PUSCH or PUCCH) may be different from the variable (such as, the number of points) for the transform pre-coding (DFT) for the RS associated with the channel.

As described above with reference to FIG. 2A, for DL transmissions, the network device 110 may perform, based on the determined variable (such as, the number of points), the transform pre-coding on a signal to be transmitted to the terminal device 120 and transmit the pre-coded signal to the terminal device 120. In response to receiving from the network device 110 the signal on which the transform pre-coding is performed based on the variable, the terminal device 120 may perform, based on the variable, the inverse transform pre-coding on the signal. As described above with reference to FIG. 2B, for UL transmissions, the terminal device 120 may perform, based on the variable (such as, the number of points), the transform pre-coding on a signal to be transmitted to the network device 110 and transmit the pre-coded signal to the network device 110. In response to receiving from the terminal device 120 the signal on which the transform pre-coding is performed based on the variable, the network device may performs, based on the variable, the inverse transform pre-coding (such as, IDFT) on the signal.

In some embodiments, for a channel (such as, PDCCH, PUSCH, PDSCH or PUCCH) and/or an associated RS (such as, CSI-RS, DMRS, PTRS, SRS or TRS), the transform pre-coding may be applied according to:

$$r ( l \cdot X + k ) = \frac{1}{\sqrt{X}} * {\sum }_{i = 0}^{X - 1} d ( l \cdot X + i ) * {e}^{- j * 2 π ik / X} \qquad ( 1 )$$

where k=0, . . . X−1, l=0, . . . Z_{symb}^{layer}/X−1, and X=N·Y. Z_{symb}^{layer} represents the number of modulation symbols per layer. For example, d(0), . . . d(Z_{symb}^{layer}−1) represent a block of complex-valued symbols before transform pre-coding. After the transform pre-coding, there may be a block of complex-valued symbols r(0), . . . r(Z_{symb}^{layer}−1).

In some embodiments, for the associated DMRS, the transform pre-coding may be applied according to:

$$r ( l \cdot w + k ) = \frac{1}{\sqrt{w}} * {\sum }_{i = 0}^{w - 1} d ( l \cdot w + i ) * {e}^{- j * 2 π ik / w} \qquad ( 2 )$$

where k=0, . . . w−1, l=0, . . . Z_{symb}^{layer}/w−1, and w=N·R. Z_{symb}^{layer} represents the number of modulation symbols per layer. For example, d(0), . . . d(Z_{symb}^{layer}−1) represent a block of complex-valued symbols before the transform pre-coding. After the transform pre-coding, there may be a block of complex-valued symbols r(0), . . . r(Z_{symb}^{layer}−1).

In view of the above, it can be seen that according to embodiments of the present disclosure, multiple terminal devices can be scheduled based on FDM in the same symbol, so as to achieve high resource efficiency. Meanwhile, since the current SC-FDMA/DFT-s-OFDM technology is reused as much as possible, the PAPR can still be maintained in a low level.

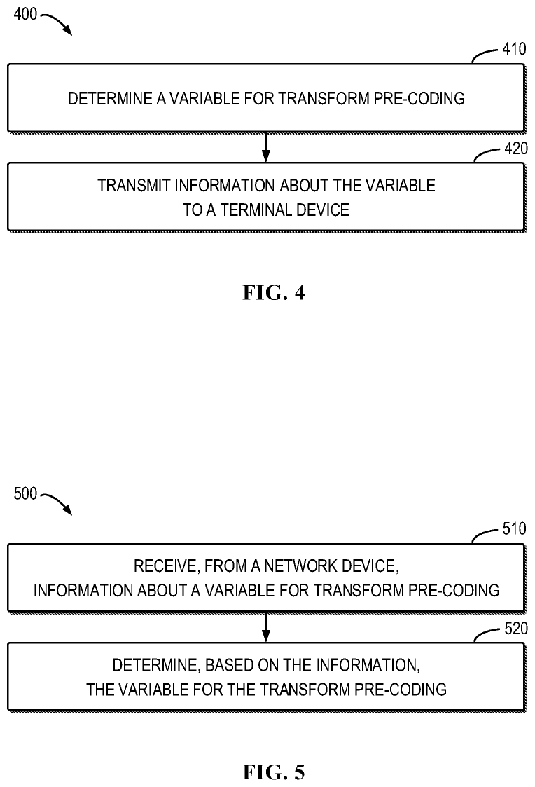

FIG. 4 illustrates a flowchart of an example method 400 in accordance with some embodiments of the present disclosure. The method 400 can be performed at the network device 110 as shown in FIG. 1. It is to be understood that the method 400 may include additional blocks not shown and/or may omit some blocks as shown, and the scope of the present disclosure is not limited in this regard.

At block 410, the network device 110 determines a variable for transform pre-coding to be performed by the network device 110 or a terminal device 120 served by the network device 110.

At block 420, the network device 110 transmits, to the terminal device 120, information about the variable for the transform pre-coding.

In some embodiments, the transform pre-coding is to be performed by the network device 110. The method 400 further comprises: performing, based on the variable, the transform pre-coding on a signal to be transmitted to the terminal device 120; and in response to the transform pre-coding being performed on the signal, transmitting the signal to the terminal device 120.

In some embodiments, the transform pre-coding is to be performed by the terminal device 120. The method 400 further comprises: receiving, from the terminal device 120, a signal on which the transform pre-coding is performed based on the variable; and performing, based on the variable, inverse transform pre-coding on the signal.

In some embodiments, the variable indicates a number of points for the transform pre-coding.

In some embodiments, determining the variable comprises: determining a number of frequency resources allocated to a plurality of terminal devices comprising the terminal device 120, wherein the plurality of terminal devices are scheduled based on Frequency Division Multiplexing in a same symbol; and determining the variable based on the number of frequency resources.

In some embodiments, determining the variable comprises: determining a plurality of frequency resources allocated to a plurality of terminal devices comprising the terminal device 120, wherein the plurality of terminal devices are scheduled based on Frequency Division Multiplexing in a same symbol; determining a starting frequency resource and an ending frequency resource of the plurality of frequency resources; determining a number of frequency resources between the starting frequency resource and the ending frequency resource; and determining the variable based on the number of frequency resources.

In some embodiments, transmitting the information to the terminal device 120 comprises: transmitting, to the terminal device 120, a message indicating the number of frequency resources.

In some embodiments, the plurality of frequency resources are discontinuous in frequency domain.

In some embodiments, transmitting the information to the terminal device 120 comprises: transmitting, to the terminal device 120, at least one message indicating a first index of the starting frequency resource and a second index of the ending frequency resource.

FIG. 5 illustrates a flowchart of an example method 500 in accordance with some embodiments of the present disclosure. The method 500 can be performed at the terminal device 120 as shown in FIG. 1. It is to be understood that the method 500 may include additional blocks not shown and/or may omit some blocks as shown, and the scope of the present disclosure is not limited in this regard.

At block 510, the terminal device 120 receives, from a network device 110 serving the terminal device 120, information about a variable for transform pre-coding to be performed by the network device 110 or the terminal device 120.

At block 520, the terminal device 120 determines, based on the information, the variable for the transform pre-coding.

In some embodiments, the transform pre-coding is to be performed by the network device 110. The method 500 further comprises: receiving, from the network device 110, a signal on which the transform pre-coding is performed based on the variable; and performing, based on the variable, inverse transform pre-coding on the signal.

In some embodiments, the transform pre-coding is to be performed by terminal device 120. The method 500 further comprises: performing, based on the variable, the transform pre-coding on a signal to be transmitted to the network device 110; and in response to the transform pre-coding being performed on the signal, transmitting the signal to the network device 110.

In some embodiments, the variable indicates a number of points for the transform pre-coding.

In some embodiments, receiving the information from the network device 110 comprises: receiving, from the network device 110, a message indicating a number of frequency resources allocated to a plurality of terminal devices comprising the terminal device 120, wherein the plurality of terminal devices are scheduled based on Frequency Division Multiplexing in a same symbol.

In some embodiments, receiving the information from the network device 110 comprises: receiving, from the network device 110, a message indicating a number of frequency resources between a starting frequency resource and an ending frequency resource of a plurality of frequency resources, wherein the plurality of frequency resources are allocated to a plurality of terminal devices comprising the terminal device 120, and the plurality of terminal devices are scheduled based on Frequency Division Multiplexing in a same symbol.

In some embodiments, receiving the information from the network device 110 comprises: receiving, from the network device 110, at least one message indicating a first index of a starting frequency resource of a plurality of frequency resources and a second index of an ending frequency resource of the plurality of frequency resources, wherein the plurality of frequency resources are allocated to a plurality of terminal devices comprising the terminal device 120, and the plurality of terminal devices are scheduled based on Frequency Division Multiplexing in a same symbol.

In some embodiments, determining the variable comprises: determining the variable based on the number of frequency resources.

In some embodiments, the plurality of frequency resources are discontinuous in frequency domain.

In some embodiments, determining the variable comprises: determining a number of frequency resources between the starting frequency resource and the ending frequency resource; and determining the variable based on the number of frequency resources.

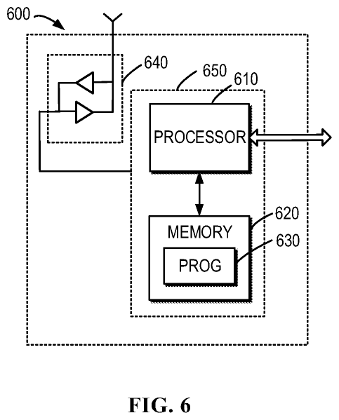

FIG. 6 is a simplified block diagram of a device 600 that is suitable for implementing embodiments of the present disclosure. The device 600 can be considered as a further example implementation of the network device 110 or the terminal device 120 as shown in FIG. 1. Accordingly, the device 600 can be implemented at or as at least a part of the network device 110 or the terminal device 120.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 4 and/or FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
determining, at a network device, a variable for transform pre-coding to be performed by the network device or a terminal device served by the network device; and
transmitting, to the terminal device, information about the variable for the transform pre-coding.

2. The method of claim 1, wherein the transform pre-coding is to be performed by the network device, and the method further comprises:
performing, based on the variable, the transform pre-coding on a signal to be transmitted to the terminal device; and
in response to the transform pre-coding being performed on the signal, transmitting the signal to the terminal device.

3. The method of claim 1, wherein the transform pre-coding is to be performed by the terminal device, and the method further comprises:
receiving, from the terminal device, a signal on which the transform pre-coding is performed based on the variable; and
performing, based on the variable, inverse transform pre-coding on the signal.

4. The method of claim 1, wherein the variable indicates a number of points for the transform pre-coding.

5. The method of claim 1, wherein determining the variable comprises:
determining a number of frequency resources allocated to a plurality of terminal devices comprising the terminal device, wherein the plurality of terminal devices are scheduled based on Frequency Division Multiplexing in a same symbol; and
determining the variable based on the number of frequency resources.

6. The method of claim 1, wherein determining the variable comprises:
determining a plurality of frequency resources allocated to a plurality of terminal devices comprising the terminal device, wherein the plurality of terminal devices are scheduled based on Frequency Division Multiplexing in a same symbol;
determining a starting frequency resource and an ending frequency resource of the plurality of frequency resources;
determining a number of frequency resources between the starting frequency resource and the ending frequency resource; and
determining the variable based on the number of frequency resources.

7. The method of claim 5, wherein transmitting the information to the terminal device comprises:
transmitting, to the terminal device, a message indicating the number of frequency resources.

8. The method of claim 6, wherein the plurality of frequency resources are discontinuous in frequency domain.

9. The method of claim 6, wherein transmitting the information to the terminal device comprises:
transmitting, to the terminal device, at least one message indicating a first index of the starting frequency resource and a second index of the ending frequency resource.

10. A method of communication, comprising:
receiving, at a terminal device and from a network device serving the terminal device, information about a variable for transform pre-coding to be performed by the network device or the terminal device; and
determining, based on the information, the variable for the transform pre-coding.

11. The method of claim 10, wherein the transform pre-coding is to be performed by the network device, and the method further comprises:
receiving, from the network device, a signal on which the transform pre-coding is performed based on the variable; and
performing, based on the variable, inverse transform pre-coding on the signal.

12. The method of claim 10, wherein the transform pre-coding is to be performed by the terminal device, and the method further comprises:
performing, based on the variable, the transform pre-coding on a signal to be transmitted to the network device; and
in response to the transform pre-coding being performed on the signal, transmitting the signal to the network device.

13. The method of claim 10, wherein the variable indicates a number of points for the transform pre-coding.

14. The method of claim 10, wherein receiving the information from the network device comprises:
receiving, from the network device, a message indicating a number of frequency resources allocated to a plurality of terminal devices comprising the terminal device,
wherein the plurality of terminal devices are scheduled based on Frequency Division Multiplexing in a same symbol.

15. The method of claim 10, wherein receiving the information from the network device comprises:
receiving, from the network device, a message indicating a number of frequency resources between a starting frequency resource and an ending frequency resource of a plurality of frequency resources,
wherein the plurality of frequency resources are allocated to a plurality of terminal devices comprising the terminal device, and the plurality of terminal devices are scheduled based on Frequency Division Multiplexing in a same symbol.

16. The method of claim 10, wherein receiving the information from the network device comprises:
receiving, from the network device, at least one message indicating a first index of a starting frequency resource of a plurality of frequency resources and a second index of an ending frequency resource of the plurality of frequency resources,
wherein the plurality of frequency resources are allocated to a plurality of terminal devices comprising the terminal device, and the plurality of terminal devices are scheduled based on Frequency Division Multiplexing in a same symbol.

17. The method of claim 14, wherein determining the variable comprises:
determining the variable based on the number of frequency resources.

18. The method of claim 15, wherein the plurality of frequency resources are discontinuous in frequency domain.

19. The method of claim 16, wherein determining the variable comprises:
determining a number of frequency resources between the starting frequency resource and the ending frequency resource; and
determining the variable based on the number of frequency resources.

20. (canceled)

21. A terminal device, comprising:
a processor; and
a memory coupled to the processor and storing instructions thereon, the instructions, when executed by the processor, causing the terminal device to:
receive, from a network device serving the terminal device, information about a variable for transform pre-coding to be performed by the network device or the terminal device; and
determine, based on the information, the variable for the transform pre-coding.

22. (canceled)

23. (canceled)
